(19) United States
(12) Patent Application Publication
(10) Pub. No.: US 2018/0070578 A1
(43) Pub. Date: Mar. 15, 2018

(54) METHOD AND APPARATUS FOR CONTROLLING WIRELESS POWER TRANSFER TO ELECTRIC VEHICLE USING OBJECT DETECTION SENSOR

(71) Applicants: Hyundai Motor Company, Seoul (KR); Kia Motors Corporation, Seoul (KR); Research & Business Foundation Sungkyunkwan University, Suwon-si (KR)

(72) Inventors: Gyu Yeong CHOE, Suwon-si (KR); Woo Young Lee, Yongin-si (KR); Min Kook Kim, Suwon-si (KR); Min Jung Kim, Suwon-si (KR); Byoung Kuk Lee, Yongin-si (KR)

(73) Assignees: Hyundai Motor Company, Seoul (KR); Kia Motors Corporation, Seoul (KR); Research & Business Foundation Sungkyunkwan University, Suwon-si (KR)

(21) Appl. No.: 15/698,330

(22) Filed: Sep. 7, 2017

(30) Foreign Application Priority Data
Sep. 9, 2016 (KR) 10-2016-0116645
Aug. 30, 2017 (KR) 10-2017-0110005

(51) Int. Cl. A01M 29/18; B60L 11/18; G01V 3/10; H02J 7/00

(52) U.S. Cl. CPC A01M 29/18; B60L 11/182; H02J 7/0029; B60L 11/1824; G01V 3/101

(57) ABSTRACT

A wireless power transfer (WPT) control method using an object detection sensor, performed at a WPT apparatus, may include detecting whether or not an object exists between a transmission pad and a reception pad mounted on an electric vehicle (EV) using an object detection sensor; in response to detecting that an object does not exist between the transmission pad and the reception pad, controlling the transmission pad to perform WPT to the reception pad; and in response to detecting that an object exists between the transmission pad and the reception pad, generating ultrasonic waves using an ultrasonic wave generator.

### CROSS-REFERENCE TO RELATED APPLICATION

The present application claims priority to Korean Patent Application No. 10-2016-0116645 filed on Sep. 9, 2016 and No. 10-2017-0110005 filed on Aug. 30, 2017, the entire contents of which is incorporated herein for all purposes by this reference.

### BACKGROUND OF THE INVENTION

### Field of the Invention

The present invention relates to a method and an apparatus for controlling wireless power transfer (WPT) to an electric vehicle (EV), more particularly, to a method and an apparatus for enhancing stability in WPT by preventing access of various objects that interferes with WPT by generating ultrasonic waves when the various objects such as animals between a transmission pad and a reception pad are detected using an object detection sensor.

### Description of Related Art

An electric vehicle (EV) charging system may basically be defined as a system for charging a high-voltage battery mounted on an EV by use of power of an energy storage device or a power grid of a commercial power source. Such the EV charging system may have various forms according to the type of EV. For example, the EV charging system may be classified into a conductive type using a charging cable and a non-contact wireless power transfer (WPT) type (also referred to as an ‘inductive type’).

When charging the EV, a vehicle assembly (VA) (i.e., a reception pad in the VA) mounted on the EV makes an inductive resonance coupling with a transmission pad of the GA located in the charging station or the charging spot, and charges the battery in the EV using power transferred from the GA through the inductive resonance coupling.

The WPT system of the inductive type is a system that transmits electric power using a mutual electromagnetic induction phenomenon between the transmission pad (i.e., a transmission coil) and the reception pad (i.e., a reception coil). Accordingly, when there is a substance including metallic or magnetic material between the transmission coil and the reception coil that can affect the magnetic field, it directly affects the resonant frequency of the WPT system, resulting in abnormal operation of the WPT system or decrease in efficiency of the WPT. Also, to prevent accidents caused by animals, it is necessary to block access of animals around the transmission pad or induce avoidance of animals.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a method of controlling wireless power transfer to an electric vehicle using an object detection sensor.

Various aspects of the present invention are directed to providing an apparatus of controlling wireless power transfer to an electric vehicle using an object detection sensor.

According to embodiments of the present invention, a WPT control method using an object detection sensor, performed at a WPT control apparatus, may comprise detecting whether or not an object exists between a transmission pad and a reception pad mounted on an electric vehicle (EV) using an object detection sensor; in response to detecting that an object does not exist between the transmission pad and the reception pad, controlling the transmission pad to perform WPT to the reception pad; and in response to detecting that an object exists between the transmission pad and the reception pad, generating ultrasonic waves using an ultrasonic wave generator.

The detecting may be performed upon detecting that the EV approaches an area where the transmission pad is located or receiving a WPT request according to a user input of the EV.

The detecting may be performed when an alignment state between the transmission pad and the reception pad is confirmed.

The object detection sensor may be disposed in the transmission pad or in a place adjacent to the transmission pad.

The object detection sensor may include at least one pressure sensor radially disposed on an upper surface of the transmission pad.

In the sensing, the object may be detected in accordance that a voltage of the at least one pressure sensor exceeds a predetermined reference voltage.

In the generating ultrasonic waves, the ultrasonic waves may be spread by use of a sound wave diffuser adjacent to the ultrasonic wave generator or disposed in combination with the ultrasonic wave generator.

The ultrasonic wave generator generates ultrasonic waves of 30 to 100 kHz.

The WPT control method may further comprise re-executing the detecting whether or not an object exists and controlling the transmission pad to stop the WPT.

The re-executing may be performed repeatedly at predetermined time intervals, or performed as an efficiency of the WPT is reduced below a threshold value.

Furthermore, in accordance with embodiments of the present invention, a WPT control apparatus using an object detection sensor may comprise at least one processor and a memory storing at least one instruction executed by the at least one processor. Also, the at least one instruction may be configured to perform a step of detecting whether or not an object exists between a transmission pad and a reception pad mounted on an electric vehicle (EV) using an object detection sensor; in response to detecting that an object does not exist between the transmission pad and the reception pad, a step of controlling the transmission pad to perform WPT to the reception pad; and in response to detecting that an object exists between the transmission pad and the reception pad, a step of generating ultrasonic waves using an ultrasonic wave generator.

The step of detecting may be performed upon detecting that the EV approaches an area where the transmission pad is located or receiving a WPT request according to a user input of the EV.

The step of detecting may be performed when an alignment state between the transmission pad and the reception pad is confirmed.

The object detection sensor may be disposed in the transmission pad or in a place adjacent to the transmission pad.

The object detection sensor may include at least one pressure sensor radially disposed on an upper surface of the transmission pad.

In the step of sensing, the object may be detected in accordance that a voltage of the at least one pressure sensor exceeds a predetermined reference voltage.

In the step of generating ultrasonic waves, the ultrasonic waves may be spread by use of a sound wave diffuser adjacent to the ultrasonic wave generator or disposed in combination with the ultrasonic wave generator.

The ultrasonic wave generator generates ultrasonic waves of 30 to 100 kHz.

The at least one instruction may be further configured to perform a step of re-executing the step of detecting whether or not an object exists and controlling the transmission pad to stop the WPT.

The step of re-executing may be performed repeatedly at predetermined time intervals, or performed as an efficiency of the WPT is reduced below a threshold value.

Using the WPT control method or WPT control apparatus using the object detection sensor according to an exemplary embodiment of the present invention as described above, it is made possible to prevent a malfunction of a WPT system due to an approach of an animal.

Also, by detecting an object and stopping transmission at the time of WPT, a safety accident of a person or an animal can be prevented.

Also, by detecting a foreign object between the transmission pad and the reception pad, the stability of the WPT operation can be remarkably improved.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF DRAWINGS

FIG. 1 is a conceptual diagram illustrating a concept of a wireless power transfer (WPT) to which an exemplary embodiment of the present invention is applied;

FIG. 2 is a conceptual diagram illustrating a wireless power transfer circuit according to an exemplary embodiment of the present invention;

FIG. 3 is a conceptual diagram for explaining a concept of alignment in an EV wireless power transfer according to an exemplary embodiment of the present invention;

FIG. 4 is a flowchart for explaining a WPT control method using an object detection sensor according to an exemplary embodiment of the present invention;

FIG. 5 is a view illustrating an example of a transmission pad on which an object detection sensor and an ultrasonic wave generator are disposed according to an exemplary embodiment of the present invention; and

FIG. 6 is a block diagram illustrating a WPT control apparatus using an object detection sensor according to an exemplary embodiment of the present invention.

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

It will be understood that although the terms “first,” “second,” etc. may be used herein to describe various components, these components should not be limited by these terms. These terms are used merely to distinguish one element from another. For example, without departing from the scope of the present invention, a first component may be designated as a second component, and similarly, the second component may be designated as the first component. The term “and/or” include any and all combinations of one of the associated listed items.

It will be understood that when a component is referred to as being “connected to” another component, it can be directly or indirectly connected to the other component. That is, for example, intervening components may be present. On the contrary, when a component is referred to as being “directly connected to” another component, it will be understood that there is no intervening components.

Terms are used herein to describe the embodiments but not to limit the present invention. Singular expressions, unless defined otherwise in contexts, include plural expressions. In the present specification, terms of “comprise” or “have” are used to designate features, numbers, steps, operations, elements, components or combinations thereof included in the specification as being present but not to exclude possibility of the existence or the addition of one or more other features, numbers, steps, operations, elements, components, or combinations thereof.

All terms including technical or scientific terms, unless being defined otherwise, have the same meaning generally understood by a person of ordinary skill in the art. It will be understood that terms defined in dictionaries generally used are interpreted as including meanings identical to contextual meanings of the related art, unless definitely defined otherwise in the present specification, are not interpreted as being ideal or excessively formal meanings.

Terms used in an exemplary embodiment of the present invention are defined as follows.

“Electric Vehicle, EV”: An automobile, as defined in 49 CFR 523.3, intended for highway use, powered by an electric motor that draws current from an on-vehicle energy storage device including a battery, which is rechargeable from an off-vehicle source including residential or public electric service or an on-vehicle fuel powered generator. The EV may be four or more wheeled vehicle manufactured for use primarily on public streets, roads.

The EV may be referred to as an electric car, an electric automobile, an electric road vehicle (ERV), a plug-in vehicle (PV), a plug-in vehicle (xEV), etc., and the xEV may be classified into a plug-in all-electric vehicle (BEV), a battery electric vehicle, a plug-in electric vehicle (PEV), a hybrid electric vehicle (HEV), a hybrid plug-in electric vehicle (HPEV), a plug-in hybrid electric vehicle (PHEV), etc.

“Plug-in Electric Vehicle, PEV”: An Electric Vehicle that recharges the on-vehicle primary battery by connecting to the power grid.

“Plug-in vehicle, PV”: An electric vehicle rechargeable through wireless charging from an electric vehicle supply equipment (EVSE) without using a physical plug or a physical socket.

“Heavy duty vehicle; H.D. Vehicle”: Any four-or more wheeled vehicle as defined in 49 CFR 523.6 or 49 CFR 37.3 (bus).

“Light duty plug-in electric vehicle”: A three or four-wheeled vehicle propelled by an electric motor drawing current from a rechargeable storage battery or other energy devices for use primarily on public streets, roads and highways and rated at less than 4,545 kg gross vehicle weight.

“Wireless power charging system, WCS”: A system for a wireless power transfer and control between the GA and VA including alignment and communications. This system transfers energy from the electric supply network to the electric vehicle electromagnetically through a two-part loosely coupled transformer.

“Wireless power transfer, WPT”: A transfer of electrical power from an AC supply network to an electric vehicle by contactless means.

“Utility”: A set of systems which supply electrical energy and include a customer information system (CIS), an advanced metering infrastructure (AMI), rates and revenue system, etc. The utility may provide an EV with energy through rates table and discrete events. Also, the utility may provide information related to certification on EVs, interval of power consumption measurements, and tariff.

“Smart charging”: A system in which EVSE and/or PEV communicate with power grid to optimize charging ratio or discharging ratio of EV by reflecting capacity of the power grid or expense of use.

“Automatic charging”: A procedure in which inductive charging is automatically performed after a vehicle is located in a proper position corresponding to a primary charger assembly that can transfer power. The automatic charging may be performed after obtaining necessary authentication and right.

“Interoperability”: A state in which component of a system interwork with corresponding components of the system to perform operations aimed by the system. Also, information interoperability may mean capability that two or more networks, systems, devices, applications, or components can efficiently share and easily use information without giving inconvenience to users.

“Inductive charging system”: A system transferring energy from a power source to an EV through a two-part gapped core transformer in which the two halves of the transformer, primary and secondary coils are physically separated from one another. In an exemplary embodiment of the present invention, the inductive charging system may correspond to an EV power transfer system.

“Inductive coupler”: A transformer formed by the coil in the GA Coil and the coil in the VA Coil that allows power to be transferred with galvanic isolation.

“Inductive coupling”: Magnetic coupling between two coils. In an exemplary embodiment of the present invention, coupling between the GA Coil and the VA Coil.

“Ground assembly, GA'”: An assembly on the infrastructure side including the GA Coil, a power/frequency conversion device and GA controller as well as the wiring from the grid and between each device, filtering circuits, housing(s) etc., necessary to function as the power source of wireless power charging system. The GA may include the communication elements necessary for communication between the GA and the VA.

“Vehicle assembly, VA”: An assembly on the vehicle including the VA Coil, rectifier/power conversion device and VA controller as well as the wiring to the vehicle batteries and between each device, filtering circuits, housing(s), etc., necessary to function as the vehicle part of a wireless power charging system. The VA may include the communication elements necessary for communication between the VA and the GA.

The GA may be referred to as a primary device (PD), and the VA may be referred to as a secondary device (SD).

“Primary device”: An apparatus which provides the contactless coupling to the secondary device. That is, the primary device may be an apparatus external to an EV. When the EV is receiving power, the primary device may act as the source of the power to be transferred. The primary device may include the housing and all covers.

“Secondary device”: An apparatus mounted on the EV which provides the contactless coupling to the primary device. That is, the secondary device may be disposed in the EV. When the EV is receiving power, the secondary device may transfer the power from the primary to the EV. The secondary device may include the housing and all covers.

“GA controller”: A portion of the GA that regulates the output power level to the GA Coil based on information from the vehicle.

“VA controller”: A portion of the VA that monitors specific on-vehicle parameters during charging and initiates communication with the GA to control output power level.

The GA controller may be referred to as a primary device communication controller (PDCC), and the VA controller may be referred to as an electric vehicle communication controller (EVCC).

“Magnetic gap”: A vertical distance between the plane of the higher of the top portion of the litz wire or the top portion of the magnetic material in the GA Coil to the plane of the lower of the bottom portion of the litz wire or the magnetic material in the VA Coil when aligned.

“Ambient temperature”: A ground-level temperature of the air measured at the subsystem under consideration and not in direct sun light.

“Vehicle ground clearance”: A vertical distance between the ground surface and the lowest part of the vehicle floor pan.

“Vehicle magnetic ground clearance”: A vertical distance between the plane of the lower of the bottom portion of the litz wire or the magnetic material in the VA Coil mounted on a vehicle to the ground surface.

“VA Coil magnetic surface distance”: A distance between the plane of the nearest magnetic or conducting component surface to the lower external surface of the VA coil when mounted. This distance includes any protective coverings and additional items that may be packaged in the VA Coil enclosure.

The VA coil may be referred to as a secondary coil, a vehicle coil, or a receive coil. Similarly, the GA coil may be referred to as a primary coil, or a transmit coil.

“Exposed conductive component”: A conductive component of electrical equipment (e.g., an electric vehicle) that may be touched and which is not normally energized but which may become energized in a case of a fault.

“Hazardous live component”: A live component, which under certain conditions can give a harmful electric shock.

“Live component”: Any conductor or conductive component intended to be electrically energized in normal use.

“Direct contact”: Contact of persons with live components. (See IEC 61440)

“Indirect contact”: Contact of persons with exposed, conductive, and energized components made live by an insulation failure. (See IEC 61140)

“Alignment”: A process of finding the relative position of primary device to secondary device and/or finding the relative position of secondary device to primary device for the efficient power transfer that is specified. In an exemplary embodiment of the present invention, the alignment may direct to a fine positioning of the wireless power transfer system.

“Pairing”: A process by which a vehicle is correlated with the unique dedicated primary device, at which it is located and from which the power will be transferred. The pairing may include the process by which a VA controller and GA controller of a charging spot are correlated. The correlation/association process may include the process of the establishment of a relationship between two peer communication entities.

“Command and control communication”: A communication between the EV supply equipment and the EV exchanges information necessary to start, control and terminate the process of WPT.

“High level communication (HLC)”: HLC is a special kind of digital communication. HLC is necessary for additional services which are not covered by command & control communication. The data link of the HLC may use a power line communication (PLC), but it is not limited.

“Low power excitation (LPE)”: LPE device a technique of activating the primary device for the fine positioning ad pairing so that the EV can detect the primary device, and vice versa.

“Service set identifier (SSID)”: SSID is a unique identifier including 32-characters attached to a header of a packet transmitted on a wireless LAN. The SSID identifies the basic service set (BSS) to which the wireless device attempts to connect. The SSID basically distinguishes multiple wireless LANs. Therefore, all access points (Aps) and all terminal/station devices that want to use a specific wireless LAN can use the same SSID. Devices that do not use a unique SSID are not able to join the BSS. Since the SSID is shown as plain text, it may not provide any security features to the network.

“Extended service set identifier (ESSID)”: ESSID is a name of the network to which you want to connect. It is similar to SSID but can be a more extended concept.

“Basic service set identifier (BSSID)”: BSSID including 48bits is used to distinguish a specific BSS. In the case of an infrastructure BSS network, the BSSID may be medium access control (MAC) of the AP equipment. For an independent BSS or ad hoc network, the BSSID can be generated with any value.

The charging station may comprise at least one GA and at least one GA controller managing the at least one GA. The GA may comprise at least one wireless communication device. The charging station may mean a place having at least one GA, which is disposed in home, office, public place, road, parking area, etc.

Additionally, it is understood that one or more of the below methods, or aspects thereof, may be executed by at least one controller. The term “controller” may refer to a hardware device that includes a memory and a processor. The memory is configured to store program instructions, and the processor is programmed to execute the program instructions to perform one or more processes which are described further below. Moreover, it is understood that the below methods may be executed by an apparatus including the controller in conjunction with one or more other components, as would be appreciated by a person of ordinary skill in the art.

In an exemplary embodiment of the present invention, a “rapid charging” may refer to a method of directly converting AC power of a power system to DC power, and supplying the converted DC power to a battery mounted on an EV. Here, a voltage of the DC power may be DC 500 volts (V) or less.

In an exemplary embodiment of the present invention, a “slow charging” may refer to a method of charging a battery mounted on an EV using AC power supplied to a general home or workplace. An outlet in each home or workplace, or an outlet disposed in a charging stand may provide the AC power, and a voltage of the AC power may be AC 220V or less. Here, the EV may further include an on-board charger (OBC) which is a device configured for boosting the AC power for the slow charging, converting the AC power to DC power, and supplying the converted DC power to the battery.

Hereinafter, embodiments according to an exemplary embodiment of the present invention will be explained in detail by referring to accompanying figures.

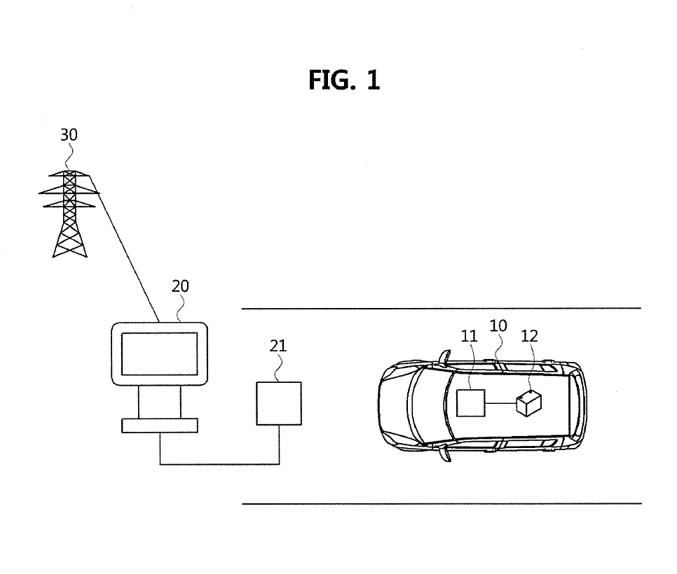

FIG. 1 is a conceptual diagram illustrating a concept of a wireless power transfer (WPT) to which an exemplary embodiment of the present invention is applied.

Referring to FIG. 1, a wireless power transfer may be performed by at least one component of an electric vehicle (EV) 10 and a charging station 13, and may be used for wirelessly transferring power to the EV 10.

Here, the EV 10 may be usually defined as a vehicle supplying an electric power stored in a rechargeable energy storage including a battery 12 as an energy source of an electric motor which is a power train system of the EV 10.

However, the EV 10 according to an exemplary embodiment of the present invention may include a hybrid electric vehicle (HEV) having an electric motor and an internal combustion engine together, and may include not only an automobile but also a motorcycle, a cart, a scooter, and an electric bicycle.

Also, the EV 10 may include a power reception pad 11 including a reception coil for charging the battery 12 wirelessly and may include a plug connection for conductively charging the battery 12. Here, the EV 10 configured for conductively charging the battery may be referred to as a plug-in electric vehicle (PEV).

Here, the charging station 13 may be connected to a power grid 15 or a power backbone, and may provide an alternating current (AC) power or a direct current (DC) power to a power transmission pad 14 including a transmission coil through a power link.

Also, the charging station 13 may communicate with an infrastructure management system or an infrastructure server that manages the power grid 15 or a power network through wired/wireless communications, and performs wireless communications with the EV 10.

Here, the wireless communications may be Bluetooth, Zigbee, cellular, wireless local area network (WLAN), or the like.

Also, for example, the charging station 13 may be located at various places including a parking area attached to the owner's house of the EV 10, a parking area for charging an EV at a gas station, a parking area at a shopping center or a workplace.

A process of wirelessly charging the battery 12 of the EV 10 may begin with first placing the power reception pad 11 of the EV 10 in an energy field generated by the power transmission pad 14 of the charging station 13, and making the reception coil and the transmission coil be interacted or coupled with each other. An electromotive force may be induced in the power reception pad 11 as a result of the interaction or coupling, and the battery 12 may be charged by the induced electromotive force.

The charging station 13 and the transmission pad 14 may be referred to as a ground assembly (GA) in whole or in portion, where the GA may refer to the previously defined meaning.

All or part of the internal components and the reception pad 11 of the EV 10 may be referred to as a vehicle assembly (VA), in which the VA may refer to the previously defined meaning.

Here, the power transmission pad 14 or the power reception pad 11 may be configured to be non-polarized or polarized.

In a case that a pad is non-polarized, there is one pole in a center of the pad and an opposite pole in an external periphery. Here, a flux may be formed to exit from the center of the pad and return at all to external boundaries of the pad.

In a case that a pad is polarized, it may have a respective pole at either end portion of the pad. Here, a magnetic flux may be formed based on an orientation of the pad.

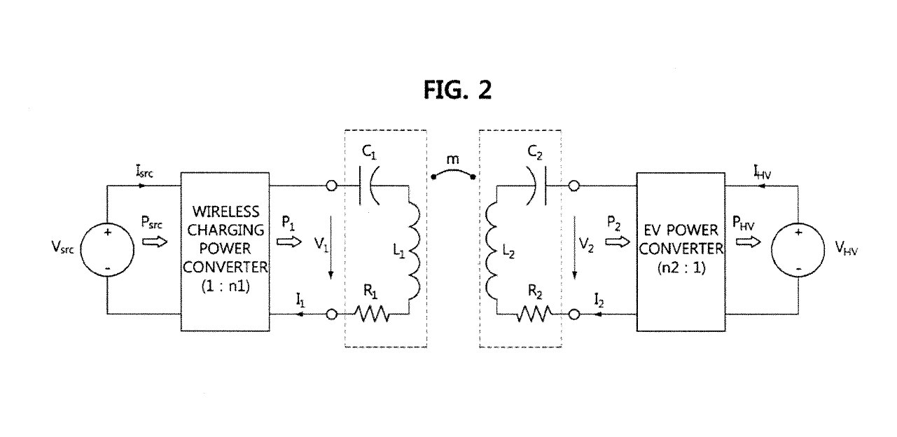

FIG. 2 is a conceptual diagram illustrating a wireless power transfer circuit according to an exemplary embodiment of the present invention.

Referring to FIG. 2, a schematic configuration of a circuit in which a wireless power transfer is performed in an EV WPT system may be seen.

Here, the left side of FIG. 2 may be interpreted as expressing all or part of a power source Vsrc supplied from the power network, the charging station 13, and the transmission pad 14 in FIG. 1, and the right side of FIG. 2 may be interpreted as expressing all or part of the EV including the reception pad and the battery.

First, the left side circuit of FIG. 2 may provide an output power Psrc corresponding to the power source Vsrc supplied from the power network to a wireless charging power converter. The wireless charging power converter may supply an output power P1 converted from the output power Psrc through frequency-converting and AC-to-DC converting to generate an electromagnetic field at a desired operating frequency in a transmission coil L1.

The wireless charging power converter may include an AC/DC converter for converting the power Psrc which is an AC power supplied from the power network into a DC power, and a low frequency (LF) converter for converting the DC power into a DC power having an operating frequency suitable for wireless charging. For example, the operating frequency for wireless charging may be determined to be within 80 to 90 kHz.

The power P1 output from the wireless charging power converter may be supplied again to a circuit including the transmission coil L1, a first capacitor C1 and a first resistor R1. Here, a capacitance of the first capacitor C1 may be determined as a value to have an operating frequency suitable for charging together with the transmission coil L1. Here, the first resistor R1 may represent a power loss occurred by the transmission coil L1 and the first capacitor C1.

Further, the transmission coil L1 may be made to have electromagnetic coupling, which is defined by a coupling coefficient m, with the reception coil L2 so that a power P2 is transmitted, or the power P2 is induced in the reception coil L2. Therefore, the meaning of power transfer in an exemplary embodiment of the present invention may be used together with the meaning of power induction.

Still further, the power P2 induced in or transferred to the reception coil L2 may be provided to an EV power converter. Here, a capacitance of a second capacitor C2 may be determined as a value to have an operating frequency suitable for wireless charging together with the reception coil L2, and a second resistor R2 may represent a power loss occurred by the reception coil L2 and the second capacitor C2.

The EV power converter may include an LF/DC converter that converts the supplied power P2 of a specific operating frequency to a DC power having a voltage level suitable for the battery VHV of the EV.

The electric power PHV converted from the power P2 supplied to the EV power converter may be output, and the power PHV may be used for charging the battery VHV disposed in the EV.

Here, the right side circuit of FIG. 2 may further include a switch for selectively connecting or disconnecting the reception coil L2 with the battery VHV. Here, resonance frequencies of the transmission coil L1 and the reception coil L2 may be similar or identical to each other, and the reception coil L2 may be positioned near the electromagnetic field generated by the transmission coil L1.

Here, the circuit of FIG. 2 may be understood as an illustrative circuit for wireless power transfer in the EV WPT system used for embodiments of the present invention, and is not limited to the circuit illustrated in FIG. 2.

On the other hand, since the power loss may increase as the transmission coil L1 and the reception coil L2 are located at a long distance, it may be an important factor to properly set the relative positions of the transmission coil L1 and the reception coil L2.

Here, the transmission coil L1 may be included in the transmission pad 14 in FIG. 1, and the reception coil L2 may be included in the reception pad 11 in FIG. 1. Therefore, positioning between the transmission pad and the reception pad or positioning between the EV and the transmission pad will be described below with reference to the drawings.

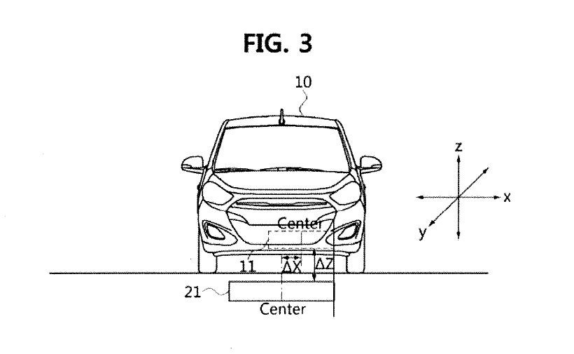

FIG. 3 is a conceptual diagram for explaining a concept of alignment in an EV wireless power transfer according to an exemplary embodiment of the present invention.

Referring to FIG. 3, a method of aligning the power transmission pad 14 and the power reception pad 11 in the EV in FIG. 1 will be described. Here, a positional alignment may correspond to the alignment, which is the above-mentioned term, and thus may be defined as a positional alignment between the GA and the VA, but is not limited to the alignment of the transmission pad and the reception pad.

Although the transmission pad 14 is illustrated as positioned below a ground surface as shown in FIG. 3, the transmission pad 14 may also be positioned on the ground surface, or positioned such that a top portion surface of the transmission pad 14 is exposed below the ground surface.

The reception pad 11 of the EV may be defined by different categories according to its heights (defined in the z direction) measured from the ground surface. For example, a class 1 for reception pads having a height of 100-150 millimeters (mm) from the ground surface, a class 2 for reception pads having a height of 140-210 mm, and a class 3 for reception pads having a height of 170-250 mm may be defined. Here, the reception pad may support a part of the above-described classes 1 to 3. For example, only the class 1 may be supported according to the type of the reception pad 11, or the class 1 and 2 may be supported according to the type of the reception pad 11.

Here, the height of the reception pad measured from the ground surface may correspond to the previously defined term ‘vehicle magnetic ground clearance’.

Further, the position of the power transmission pad 14 in the height direction (i.e., defined in the z direction) may be determined to be located between the maximum class and the minimum class supported by the power reception pad 11. For example, when the reception pad supports only the class 1 and 2, the position of the power transmission pad 14 may be determined between 100 and 210 mm with respect to the power reception pad 11.

Still further, a gap between the center of the power transmission pad 14 and the center of the power reception pad 11 may be determined to be located within the limits of the horizontal and vertical directions (defined in the x and y directions). For example, it may be determined to be located within ±75 mm in the horizontal direction (defined in the x direction), and within ±100 mm in the vertical direction (defined in the y direction).

Here, the relative positions of the power transmission pad 14 and the power reception pad 11 may be varied in accordance with their experimental results, and the numerical values should be understood as exemplary.

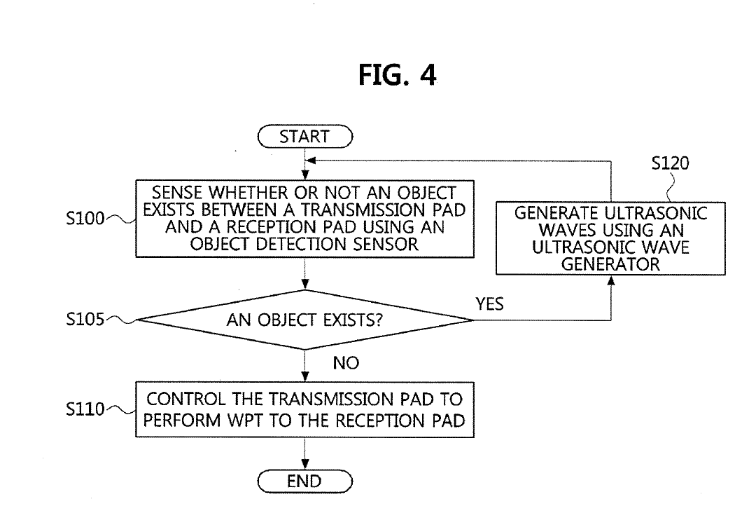

FIG. 4 is a flowchart for explaining a WPT control method using an object detection sensor according to an exemplary embodiment of the present invention.

Referring to FIG. 4, a WPT control method using an object detecting sensor may comprise a step S100 of detecting whether an object exists between a transmission pad and a reception pad mounted on an EV by use of an object detection sensor, and a step S110 of performing WPT to the reception pad by controlling the transmission pad when the object is not detected at a step S105.

Here, the object detection sensor may be disposed in the transmission pad or in a place adjacent to the transmission pad. Examples of the object detection sensor may include at least one pressure sensor, at least ultrasonic sensor, or at least one infrared sensor. The ultrasonic sensor or the infrared sensor may sense an object existing around the transmission pad or an object approaching the transmission pad, in addition to detecting an object between the transmission pad and the reception pad.

The WPT method may further comprise, when the object is detected at the step S105 after the step S100 of sensing, a step S120 of generating ultrasonic waves using an ultrasonic wave generator.

Also, after the step S120, the step S100 may be performed again.

Here, the step S100 may be performed upon detecting that the EV approaches an area where the transmission pad is located or receiving a WPT request according to a user input of the EV.

In addition, the step S100 may be performed when an alignment state between the transmission pad and the reception pad is confirmed. For example, the step S100 may be performed after confirming that alignment conditions between the transmission pad and the reception pad are satisfied. Here, the alignment conditions may refer to the description with reference to FIG. 3.

In the step S120 of generating ultrasonic waves, the ultrasonic waves may be spread by use of a sound wave diffuser adjacent to the ultrasonic wave generator or disposed in combination with the ultrasonic wave generator.

Also, the step S110 of transferring wireless power may further include a step of re-executing the step S100 of detecting an object and stopping the WPT when an object is sensed.

Here, the step of re-executing the step S100 may be repeatedly performed at predetermined time intervals, or may be performed as an efficiency of the WPT is reduced below a threshold value. That is, even after the step S110 of performing WPT is started, when a predetermined condition is satisfied, the step S100 of detecting an object may be re-executed to determine whether or not an object exists. When an object exists, ultrasonic waves may be generated using the ultrasonic wave generator.

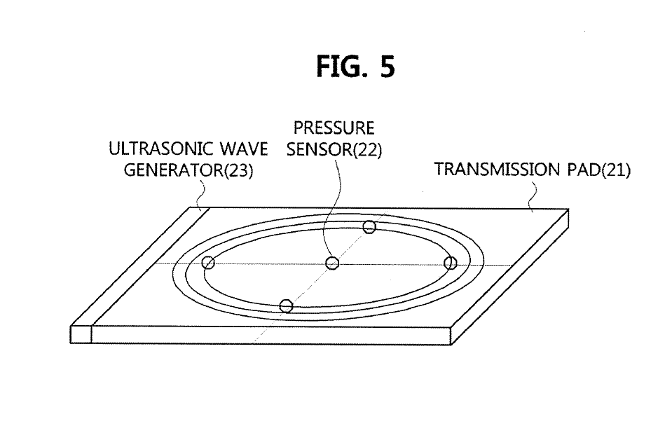

FIG. 5 is a view illustrating an example of a transmission pad on which an object detection sensor and an ultrasonic wave generator are disposed according to an exemplary embodiment of the present invention.

Referring to FIG. 5, an example in which an object detection sensor is disposed on the transmission pad is illustrated. For example, an object detection sensor may include at least one pressure sensor, and the at least one pressure sensor 22 may be disposed with a predetermined interval so as t to surround a center of the transmission pad or a center of a transmission coil provided inside the transmission pad.

As shown in FIG. 3, the transmission pad 21 may be provided as protruding above a ground surface or may be provided below the ground surface. Since animals or the like pass or lie on an upper surface of the transmission pad 21, objects including animals may be easily detected by disposing the at least one pressure sensor 22 on the upper surface of the transmission pad 21.

For example, the object detection sensor according to an exemplary embodiment of the present invention may include the at least one pressure sensor 22 radially disposed on the upper surface of the transmission pad 21.

The at least one pressure sensor 220 may be positioned on the upper surface of the transmission coil provided on the transmission pad. The at least one pressure sensor 220 may be positioned at a predetermined interval on the upper surface of the transmission coil or may be positioned at the center of the transmission coil, as shown in FIG. 5.

Further, the at least one pressure sensor 22 may detect a voltage change using a piezoelectric effect of a piezoelectric element, and may detect a resistance change. Here, when a pressure sensor of a type that detects a voltage change is used, the object may be detected based on a voltage detected by the pressure sensor. That is, in FIG. 4, the step S100 of detecting whether an object exists may sense an object according to whether or not a voltage of the pressure sensor exceeds a preconfigured reference voltage.

On the other hand, the ultrasonic wave generator 23 may be disposed on the transmission pad 21 or in a place adjacent to the transmission pad 21. Here, the ultrasonic wave generator 23 may refer to a device that generates sound waves in a range exceeding the human audible frequency range. The audio frequency region of a person or an animal is shown in Table 1 below.

TABLE 1

| Classification | Audible frequency range |
|---|---|
| Human | 20 Hz-20 kHz |
| Dog | 64 Hz-44 kHz |
| Cat | 55 Hz-77 kHz |
| Rat | 900 Hz-79 kHz |
| Raccoon | 100 Hz-40 kHz |

Referring to Table 1 above, a human can hear sounds in the frequency range of 20 Hz to 20 kHz, while other animals including dogs and cats can hear sounds in the frequency range higher than 20 kHz. Therefore, by generating ultrasonic waves corresponding to a frequency range of 20 kHz or more, which is a frequency range not recognizable by a human, only animals can be selectively driven out.

Therefore, the ultrasonic wave generator 23 may be an apparatus for generating ultrasonic waves of 30 to 100 kHz. Ultrasonic waves of 30 to 40 kHz may be generated. Here, when the ultrasonic wave of 30 to 40 kHz is used, the frequency band with other electronic devices including a vehicle smart key (SMK) system may not overlap, and there is an effect of mitigating signal interferences.

Also, the ultrasonic wave generator 23 may be configured to generate ultrasonic waves for a predetermined time (e.g., 3 seconds, 5 seconds, 10 seconds, etc.) once at a predetermined time interval (e.g., 10 seconds, 30 seconds, or 1 minute).

Although an ultrasonic wave generator for generating ultrasonic waves exceeding the human audible frequency range is taken as an example in the present embodiment, a device for generating a warning sound in the human audible frequency range (e.g., 20 Hz to 20,000 Hz) is not excluded.

By installing a device that generates a warning sound separately from the ultrasonic wave generator, a driver or system administrator of the EV may identify a threat of safety accidents due to the approach of an animal or a person when the wireless power is transferred, and may rapidly take countermeasures.

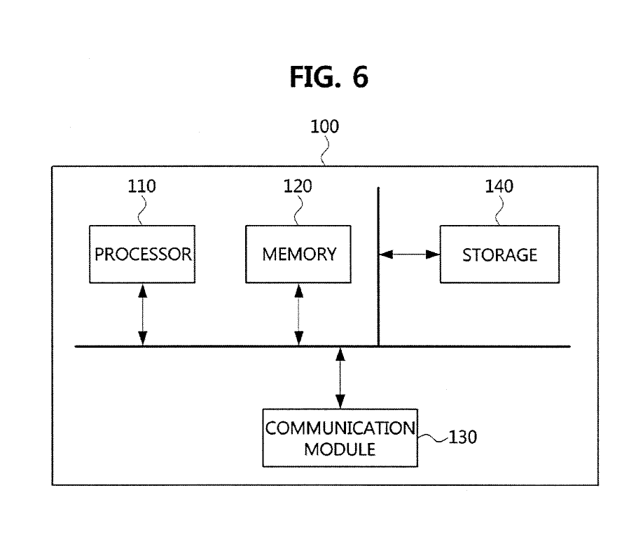

FIG. 6 is a block diagram illustrating a WPT control apparatus using an object detection sensor according to an exemplary embodiment of the present invention.

Referring to FIG. 6, a WPT control apparatus 100 may comprise at least one processor 110 and a memory 120 for storing instructions executed by the at least one processor 110. Also, the instructions stored in the memory 120 may be configured to make the at least one processor 110 perform one or more steps.

Here, the WPT control apparatus 100 may include a communication module 130 for communicating with an EV, and transmitting and receiving messages to or from the object detection sensor, the ultrasonic wave generator, and the sound wave diffusor. That is, the WPT control apparatus 100 may transmit various control commands to the ultrasonic wave generator, the object detection sensor, and the sound wave diffusor, and may receive an object detection result from the object detection sensor. Also, the WPT control apparatus 100 may further include a storage 140 for storing the object detection result.

The one or more steps may comprise a step of detecting whether an object exists between the transmission pad and the reception pad mounted on the EV by use of the object detection sensor, and a step of transferring wireless power to the reception pad by controlling the transmission pad when the object is not sensed.

The one or more steps may further comprise, when the object is sensed, a step of generating ultrasonic waves using the ultrasonic wave generator.

Here, the step of detecting whether an object exists may be performed upon detecting that the EV approaches an area where the transmission pad is located or receiving a WPT request according to a user input of the EV.

The step of detecting whether an object exists may be performed when an alignment state of the transmission pad and the reception pad is confirmed.

The object detection sensor may be disposed on the transmission pad or in a place adjacent to the transmission pad. Also, the object detection sensor may include at least one pressure sensor radially disposed on the upper surface of the transmission pad.

In the step of detecting whether an object exists, the object may be detected according to whether or not the voltage of at least one pressure sensor constituting the object detection sensor exceeds a predetermined reference voltage.

Here, the step of generating ultrasonic waves may be controlled such that ultrasonic waves are spread by use of a sound wave diffuser adjacent to the ultrasonic wave generator or disposed in combination with the ultrasonic wave generator. The ultrasonic wave generator may be an apparatus for generating ultrasonic waves of 30 to 100 kHz.

The one or more steps may further comprise a step of re-executing the step of detecting whether an object exists and a step of stopping the WPT when the object is detected. Here, the step of re-executing the step of detecting whether an object exists may be performed repeatedly at a predetermined time interval or may be performed as the efficiency of the WPT is reduced below a threshold value.

The WPT control apparatus 100 may be implemented as incorporated into the charging station according to FIG. 1 or independently. In addition, for example, the WPT control apparatus 100, which is implemented independently of the charging station, may receive a command from the charging station to sense an object and generate ultrasonic waves. When the object is not detected, a message requesting WPT may be transmitted from the WPT control apparatus 100 to the charging station.

The communication module 130 of the WPT control apparatus 100 may also be referred to as a Supply Equipment Communication Controller (SECC) when implemented in combination with the charging station according to FIG. 1.

The methods according to embodiments of the present invention may be implemented as program instructions executable by a variety of computers and recorded on a computer readable medium. The computer readable medium may include a program instruction, a data file, a data structure, or a combination thereof. The program instructions recorded on the computer readable medium may be designed and configured for an exemplary embodiment of the present invention or can be publicly known and available to those who are skilled in the field of computer software.

Examples of the computer readable medium may include a hardware device including ROM, RAM, and flash memory, which are configured to store and execute the program instructions. Examples of the program instructions include machine codes made by, for example, a compiler, as well as high-level language codes executable by a computer, using an interpreter. The above exemplary hardware device can be configured to operate as at least one software module to perform the operation of the present invention, and vice versa.

While some aspects of the present invention have been described in the context of an apparatus, it may also represent a description according to a corresponding method, wherein the block or apparatus corresponds to a method step or a feature of the method step. Similarly, aspects described in the context of a method may also be represented by features of the corresponding block or item or corresponding device. Some or all of the method steps may be performed by (or using) a hardware device such as, for example, a microprocessor, a programmable computer, or an electronic circuit. In various exemplary embodiments, one or more of the most important method steps may be performed by such an apparatus.

In embodiments, a programmable logic device (e.g., a field programmable gate array (FPGA)) may be used to perform some or all of the functions of the methods described herein. In embodiments, the FPGA may operate in conjunction with a microprocessor to perform one of the methods described herein. Generally, the methods are preferably performed by some hardware device.

For convenience in explanation and accurate definition in the appended claims, the terms “upper”, “lower”, “internal”, “outer”, “up”, “down”, “upper”, “lower”, “upwards”, “downwards”, “front”, “rear”, “back”, “inside”, “outside”, “inwardly”, “outwardly”, “internal”, “external”, “internal”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the disclosure be defined by the Claims appended hereto and their equivalents.

What is claimed is:

1. A wireless power transfer (WPT) control method using an object detection sensor, performed at a WPT control apparatus, the method comprising:
detecting whether an object exists between a transmission pad and a reception pad mounted on an electric vehicle (EV) using the object detection sensor;
in response to detecting that the object does not exist between the transmission pad and the reception pad, controlling the transmission pad to perform WPT to the reception pad; and
in response to detecting that the object exists between the transmission pad and the reception pad, generating ultrasonic waves using an ultrasonic wave generator.

2. The WPT control method, according to claim 1, wherein the detecting is performed upon detecting that the EV approaches a predetermined area where the transmission pad is located or receiving a WPT request according to a user input of the EV.

3. The WPT control method, according to claim 1, wherein the detecting is performed when an alignment state between the transmission pad and the reception pad is confirmed.

4. The WPT control method, according to claim 1, wherein the object detection sensor is disposed in the transmission pad or in a place adjacent to the transmission pad.

5. The WPT control method, according to claim 4, wherein the object detection sensor includes at least one pressure sensor radially disposed on an upper surface of the transmission pad.

6. The WPT control method, according to claim 5, wherein, in the detecting, the object is detected in accordance that a voltage of the at least one pressure sensor exceeds a predetermined reference voltage.

7. The WPT control method, according to claim 1, wherein, in the generating ultrasonic waves, the ultrasonic waves are spread by use of a sound wave diffuser adjacent to the ultrasonic wave generator or disposed in combination with the ultrasonic wave generator.

8. The WPT control method, according to claim 1, wherein the ultrasonic wave generator generates ultrasonic waves of 30 to 100 kHz.

9. The WPT control method, according to claim 1, further including re-executing the detecting whether the object exists and controlling the transmission pad to stop the WPT.

10. The WPT control method, according to claim 9, wherein the re-executing is performed repeatedly at predetermined time intervals, or performed as an efficiency of the WPT is reduced below a threshold value.

11. A wireless power transfer (WPT) control apparatus using an object detection sensor comprising at least one processor and a memory storing at least one instruction executed by the at least one processor, wherein the at least one instruction is configured to perform:
a step of detecting whether an object exists between a transmission pad and a reception pad mounted on an electric vehicle (EV) using the object detection sensor;
in response to detecting that the object does not exist between the transmission pad and the reception pad, a step of controlling the transmission pad to perform WPT to the reception pad; and
in response to detecting that the object exists between the transmission pad and the reception pad, a step of generating ultrasonic waves using an ultrasonic wave generator.

12. The WPT control apparatus, according to claim 11, wherein the step of detecting is performed upon detecting that the EV approaches a predetermined area where the transmission pad is located or receiving a WPT request according to a user input of the EV.

13. The WPT control apparatus, according to claim 11, wherein the step of detecting is performed when an alignment state between the transmission pad and the reception pad is confirmed.

14. The WPT control apparatus, according to claim 11, wherein the object detection sensor is disposed in the transmission pad or in a place adjacent to the transmission pad.

15. The WPT control apparatus, according to claim 14, wherein the object detection sensor includes at least one pressure sensor radially disposed on an upper surface of the transmission pad.

16. The WPT control apparatus, according to claim 15, wherein, in the step of sensing, the object is detected in accordance that a voltage of the at least one pressure sensor exceeds a predetermined reference voltage.

17. The WPT control apparatus, according to claim 11, wherein, in the step of generating ultrasonic waves, the ultrasonic waves are spread by use of a sound wave diffuser adjacent to the ultrasonic wave generator or disposed in combination with the ultrasonic wave generator.

18. The WPT control apparatus, according to claim 11, wherein the ultrasonic wave generator generates ultrasonic waves of 30 to 100 kHz.

19. The WPT control apparatus, according to claim 11, wherein the at least one instruction is further configured to perform a step of re-executing the step of detecting whether the object exists and controlling the transmission pad to stop the WPT.

20. The WPT control apparatus, according to claim 19, wherein the step of re-executing is performed repeatedly at predetermined time intervals, or performed as an efficiency of the WPT is reduced below a threshold value.
